(19) United States
(12) Patent Application Publication
(10) Pub. No.: US 2010/0326973 A1
(43) Pub. Date: Dec. 30, 2010

(54) METHOD OF MANUFACTURING DIAMOND PIPES AND TUBES

(76) Inventor: Dino Scorziello, Plainville, MA (US)

Correspondence Address: Dino Scorziello, 1525 E 2nd St., Apt. 315, Granbury, TX, 76048, US

(21) Appl. No.: 12/494,196

(22) Filed: Jun. 29, 2009

(51) Int. Cl. B23K 26/00

(52) U.S. Cl. 219/121.72

(57) ABSTRACT

Diamond pipes (22), (24), (26), (28), and tubes can be stronger and have thinner walls than conventional pipes. Diamond pipes and tubes are well suited for industrial processes. Diamond pipes and tubes can be cut from diamond stock (10) using a computer guided cutting laser. The computer guided cutting laser can be used to minimize the amount of excess diamond (20). The excess diamond (20) and solid diamond core (30) remaining after the cutting process can be used for other purposes. Pipes and tubes of different shapes can be made using a computer guided cutting laser.

### CROSS REFERENCE TO RELATED APPLICATIONS

Not applicable.

### BACKGROUND

1. Field of Invention

This invention relates to diamond pipes and tubes and a way of manufacturing them.

2. Description of Prior Art

Currently pipes and tubes are made of many different materials including various metals and plastics. Some are also made of composite materials such as concrete and carbon fiber. However no large bore pipes or tubes have been made from diamond. Diamond is the hardest material known to man at this point. It has a Mohs Hardness of 10. It also has an excellent thermal conductivity and thermal diffusivity. Diamond is chemically inert at low temperature. Using a process such as that described in U.S. Pat. No. 7,547,358 by Shapiro it is possible to mass produce inexpensive diamond that can be made into pipes and tubes. Due to diamond's unique properties diamond pipes and tubes can be thinner and stronger than current pipes and tubes.

In U.S. Pat. No. 6,880,624, Pinneo describes making a diamond tube by preparing a mandrel to accept chemical vapor deposition of diamond, then dissolving the mandrel in acid. With his method only one tube can be made per mandrel. This is time consuming and dangerous. A faster and easier way of making many pipes and tubes will be disclosed herein.

### SUMMARY

In accordance with the present invention pipes and tubes are made from diamond with a Mohs Hardness of 10 without the use of a mandrel. Diamond pipes and tubes are made by using a laser to cut them out of a larger piece of diamond, saving time and money.

### OBJECTS AND ADVANTAGES

Accordingly, several objects and advantages of the present invention are:
(a) to provide strong, thin walled pipes and tubes for fluid transport.
(b) to provide pipes and tubes with excellent heat transfer capabilities.
(c) to provide a simple method of pipe and tube production using a computer guided cutting laser.
(d) to provide a safer and less caustic method of producing diamond pipes and tubes.
(e) the excess diamond remaining after the cutting process can be made into tools or used for other purposes.

Still further objects and and advantages will become apparent from a consideration of the ensuing description and drawings.

### DRAWING FIGURES

In the drawings, closely related figures have the same number but different alphabetical suffixes.

FIG. 1a shows the side view of a typical piece of diamond bar stock.

FIG. 1b shows an end view of the diamond bar stock with concentric circles representing the various pipe and tube sizes to be cut from the diamond.

FIG. 2 shows a side view of some of the various sizes of diamond pipe cut from the original piece of diamond bar stock.

### REFERENCE NUMERALS IN DRAWINGS

10—diamond bar stock
15—concentric circle pattern for various sizes of pipes and tubes
20—excess diamond
22—diamond pipe 1
24—diamond pipe 2
26—diamond pipe 3
28—diamond pipe 4
30—solid diamond bar

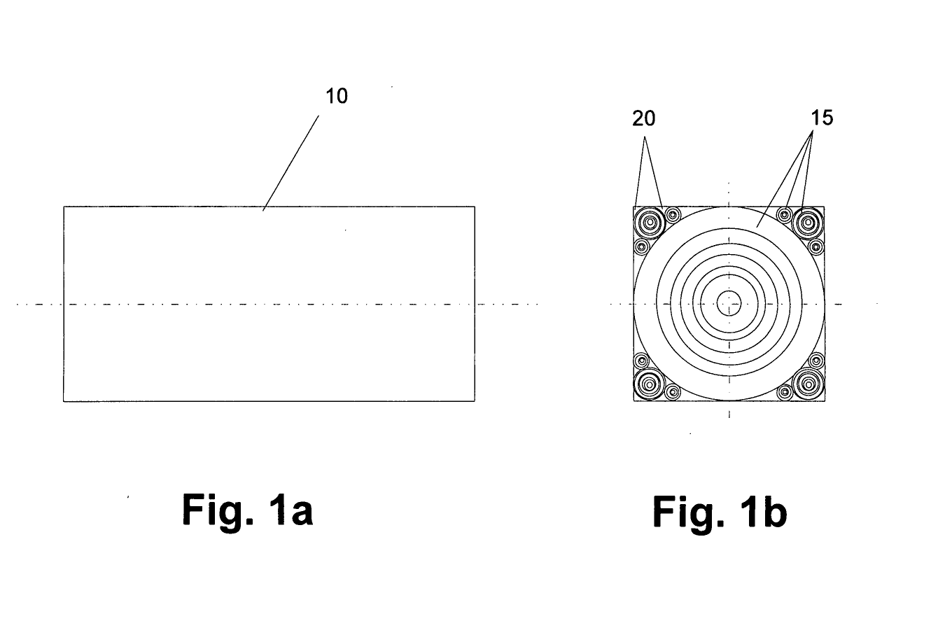

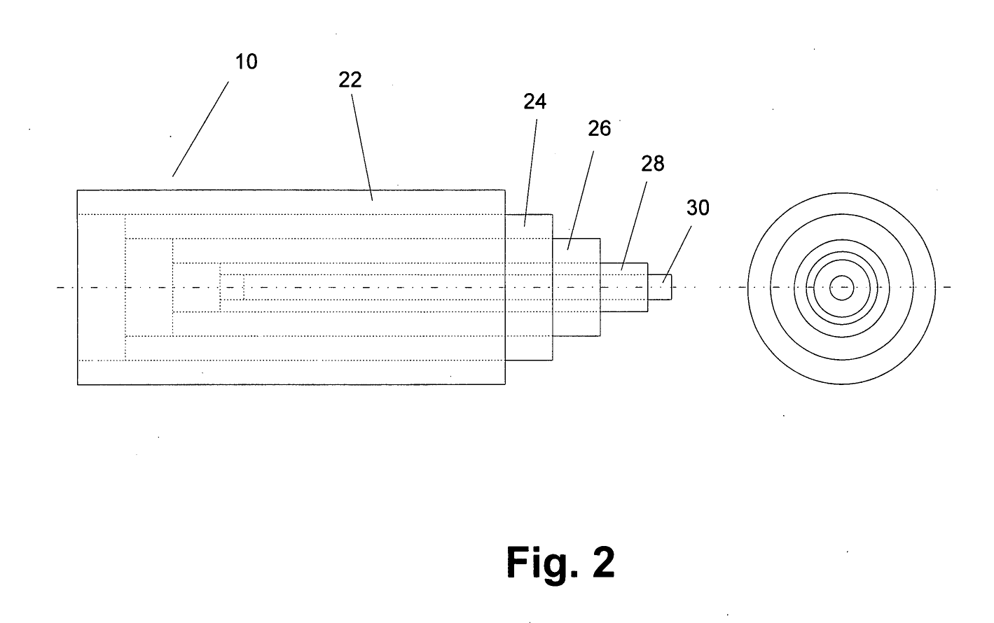

### DESCRIPTION—FIGS. 1a, 1b, 2—PREFERRED EMBODIMENT

Those of ordinary skill in the art will realize that the following description of the present invention is illustrative only and not in any way limiting. Other embodiments of the invention will readily suggest themselves to those skilled in the art.

FIG. 1a shows the side of a piece of diamond bar stock 10. It can be square, rectangular, round or whatever shape is available to produce the desired pipe(s) and/or tube(s). FIG. 1b shows a pattern of concentric circles 15 on the end of the diamond bar stock. The circles are projected on to the end with a weak laser by a laser guided cutting machine. Excess diamond 20 is produced after the cutting process. A computer guided cutting laser is used to reduce the amount of excess diamond.

FIG. 2 shows the various pieces of diamond pipe produced after the cutting process. The first diamond pipe 22 is the largest. The other pipes have various diameters 24, 26, and 28. The center piece of diamond is a solid bar 30.

### Advantages

From the description above, a number of advantages of my diamond pipes and tubes become evident:
(a) Diamonds are lighter but stronger than metal pipes. This allows diamond pipes to have thinner walls than current pipes.
(b) Diamond pipes and tubes are well suited for industrial processes.
(c) Diamond pipes and tubes can be used in most applications regular pipes and tubes are used.
(d) Using computer guided cutting laser to cut the diamond pipe and tube out of a larger piece of diamond helps to utilize the most amount of diamond available for production. Waste is minimized.
(e) Using computer guided cutting laser to cut the diamond pipe and tube out of a larger piece of diamond allows for greater accuracy and therefore thinner walled pipes and tubes.

### Operation—FIGS. 1a, 1b, 2

The diamond bar stock 10 can be made into the desired size and shape or cut into the desired size and shape using standard diamond production and cutting techniques currently used in the art including grinding, cutting/cleaving and laser cutting.

Computer generated concentric circle cutting patterns 15 are used to determine pipe and tube wall thickness and diameter. The cutting patterns 15 are targeted on to the end of the diamond bar stock 10 to ensure the desired pipes and tubes are properly cut from the bar. A computer guided cutting laser is used to cut the various sized pipes 22, 24, 26, 28 and tubes from the diamond bar stock 10 following the concentric circle patterns 15. This is easily done by people skilled in the art of using computer guided cutting lasers. A computer guided cutting laser also allows for different shapes of pipe and tubes to be cut such as square and rectangular pipes if desired. Concentric square, triangular or rectangular cutting patterns can be projected onto the end of a diamond bar stock to produce square, triangular or rectangular pipes and tubes if desired. The computer guided laser can then be used to cut the pipes and tubes to the desired length.

Excess diamond 20 and the solid diamond core 30 remaining from the cutting process can be recycled into other useful products. Excess diamond can be reduced by using the computer guided cutting laser to cut smaller useful tubes from all areas of the bar stock. Use of a computer guided cutting laser is preferred to other cutting methods because they provide accuracy and produce less waste than if the cutting laser were guided by hand. They are also fast and efficient.

### CONCLUSION, RAMIFICATION AND SCOPE

Accordingly the reader will see that diamond pipes and tubes are very useful and the method described to make them can generate several different pipe sizes from one piece of diamond stock. The use of a computer guided cutting laser helps to reduces waste. A computer guided cutting laser also allows for square, and rectangular pipes to be cut from diamond. Non standard shapes such as triangular pipes can also be produced if desired. Diamond pipes and tubes can be used in most applications regular pipes and tubes are used. Excess diamond remaining after the cutting process can be reused for different purposes.

Although the description above contains many specificities, these should not be construed as limiting the scope of the invention but as merely providing illustrations of some of the presently preferred embodiments of this invention. The invention therefore is not restricted except in the spirit of the appended claims.

I claim:

1. A method of producing diamond pipes and tubes comprising:
diamond,
computer guided cutting laser,
whereby said computer guided cutting laser is used to cut concentric pipes and tubes from said diamond.
